(19) United States
(12) Patent Application Publication
(10) Pub. No.: US 2007/0181325 A1
(43) Pub. Date: Aug. 9, 2007

(54) Extension Cord with Electromagnetic Radiation-Shielding Function

(76) Inventors: Kuo Hung Liao, Taipei County (TW); Pen Yen Chang, Taipei County (TW)

Correspondence Address: BANGER SHIA, 204 CANYON CREEK, VICTORIA, TX, 77901, US

(21) Appl. No.: 11/307,476

(22) Filed: Feb. 9, 2006

(51) Int. Cl. H01B 11/02

(52) U.S. Cl. 174/34

(57) ABSTRACT

An extension cord includes a body for connecting a two-slot socket to a three-slot socket, a detecting circuit electrically connected to the body for detecting a hot wire and a neutral wire of the two-slot socket, and a grounding circuit electrically connected to the body and mounted between the neutral wire of the two-slot socket and a grounding slot of the three-slot socket. The extension cord further includes a cable covered with a metal wire-weaved net for electrical connection with the two-slot socket. The detecting circuit includes a slide switch and an indicator. The slide switch includes a metal housing. The indicator is electrically connected in series to a resistor. The grounding circuit includes a resettable positive temperature coefficient electric fuse or a meltable fuse.

### BACKGROUND OF THE INVENTION

1. Field of the Invention

The present invention relates to an extension cord, and more particularly to an extension cord that provides an electromagnetic radiation-shielding function.

2. Description of the Related Art

A wall socket in an old building generally has only two slots, i.e., without the grounding slot. A user of 3C products (Computing, Communications and Consumer electronics products) has to break and remove the grounding prong of the plug. The electromagnetic shielding effect provided by the grounding prong is lost, and the user is thus exposed in an environment full of electromagnetic radiation.

### SUMMARY OF THE INVENTION

An objective of the present invention is to provide an extension cord with an electromagnetic radiation-shielding function.

Another objective of the present invention is to provide an extension cord for detecting a hot wire and a neutral wire of a two-slot socket.

An extension cord with an electromagnetic radiation-shielding function in accordance with the present invention comprises a body for connecting a two-slot socket to a three-slot socket, a detecting circuit for detecting a hot wire and a neutral wire of the two-slot socket, the detecting circuit being electrically connected to the body, and a grounding circuit electrically connected to the body and mounted between the neutral wire of the two-slot socket and a grounding slot of the three-slot socket.

Preferably, the extension cord further comprises a cable covered with a metal wire-weaved net for electrical connection with the two-slot socket.

Preferably, the detecting circuit comprises a slide switch and an indicator. The slide switch comprises a metal housing. The indicator is electrically connected in series to a resistor.

Preferably, the grounding circuit comprises a resettable positive temperature coefficient electric fuse or a meltable fuse.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic view of an extension cord in accordance with the present invention.

FIG. 2 is a circuit diagram of the extension cord in accordance with the present invention.

### DETAILED DESCRIPTION OF THE INVENTION

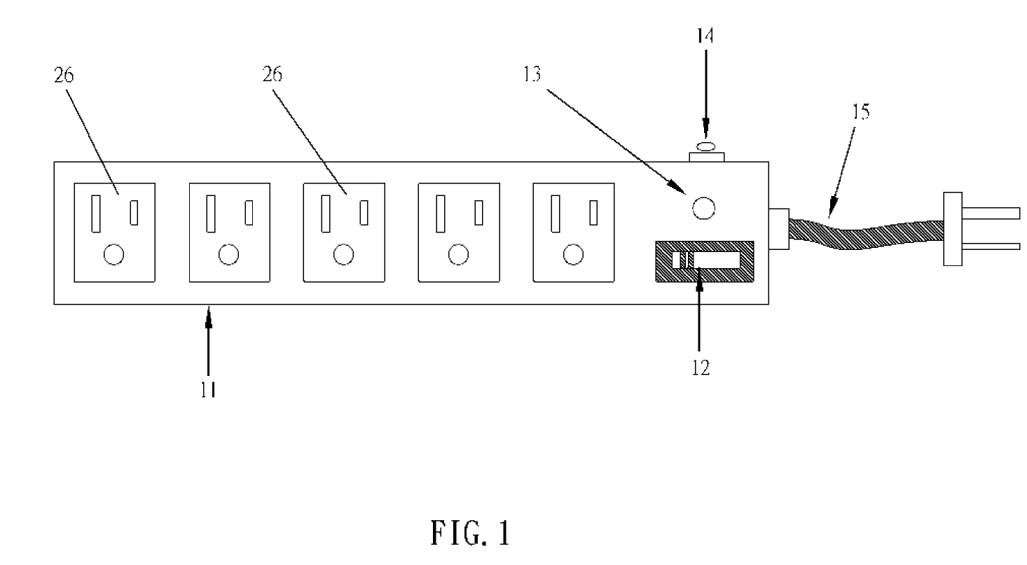

Referring to FIG. 1, an extension cord in accordance with the present invention comprises a body 11 including one ore more three-slot sockets 26, a slide switch 12, an indicator lamp 13, a fuseless overcurrent switch 14, a cable 15, and a plug 16 on an end of the cable 15.

The slide switch 12 is mounted to a front end of the body 11 and includes a metal housing for grounding purposes when a user touches the metal housing. The slide switch 12 is movable between two positions respectively in association with a hot wire and a neutral wire of a two-slot socket. The indicator lamp 13 is on when the slide switch 12 is shifted to the hot wire. On the other hand, the indicator lamp 13 is off when the slide switch 12 is shifted to the neutral wire.

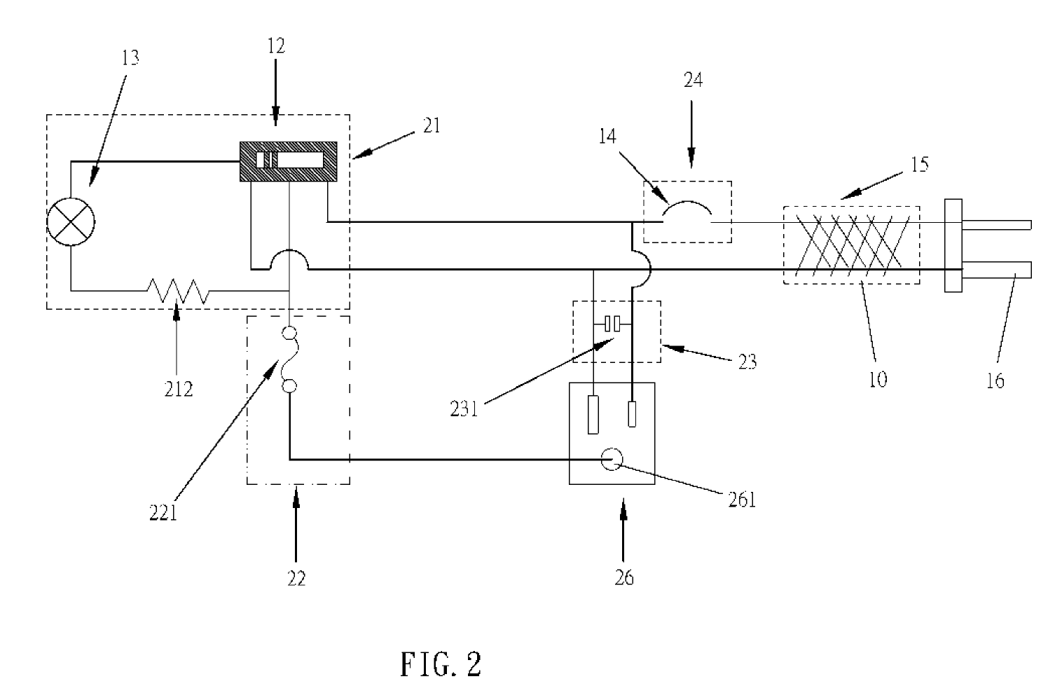

The fuseless overcurrent switch 14 is mounted on a side of the body 11 and of automatically or manually resettable type. The cable 15 is electrically connected to the body 11. Preferably, the cable 15 is covered with a metal wire-weaved net 10 and capable of shielding from electromagnetic waves. The plug 16 in this example includes two blades (not labeled) for connection with a two-slot socket. Nevertheless, the plug 16 may include two blades and a grounding prong that can be broken and removed for coupling with a two-slot socket of an alternating-current power supply. Referring to FIG. 2, the extension cord further comprises a detecting circuit 21, a grounding circuit 22, a surge protection circuit 23, and an overload protection circuit 24. The detecting circuit 21 comprises the slide switch 12 having three contacts, wherein a first contact and a second contact of the slide switch 12 are respectively connected to the hot line and the neutral line of the two-slot socket of an alternating-current power supply, and a third contact of the slide switch 12 is connected to a resistor 212, which, in turn, is connected in series to an end the indicator 13. The other end of the indicator 13 is electrically connected to the metal housing of the slide switch 12 for grounding purposes when the user touches the metal housing with his or her hand. Hence, no matter which slot of the socket is the neutral slot, the user's touching the metal housing can be grounded via switching of the slide switch 12. As mentioned above, the indicator lamp 13 is on when the slide switch 12 is shifted to the hot wire and the indicator lamp 13 is off when the slide switch 12 is shifted to the neutral wire. The user may select the neutral wire of an alternating-current power supply, and the indicator lamp 13 is off. The slide switch 12 may be a SPDT (single-pole double-throw) slide switch.

The grounding circuit 22 includes a fuse 221 having an end electrically connected to a grounding line selected by the slide switch 12. The other end of the fuse 221 is electrically connected to a third, grounding slot 261 of a three-slot socket 26. The electromagnetic radiation of the 3C product can be eliminated through the effective grounding. The fuse 221 may be a resettable PTC (positive temperature coefficient) electric fuse. The temperature coefficient of the fuse 221 changes due to overload.

The resistance is thus increased to cut off the circuit, providing the required protection. The circuit is returned to its original conductive state after relief of the overload. Thus, dismantling of the body 11 for replacement of the fuse 221 is not required. Alternatively, the fuse 221 may be a conventional meltable fuse.

The surge protection circuit 23 comprises a surge absorber 231 mounted across a hot wire (not labeled) and a neutral wire (not labeled) of the three-slot socket 26. When surge reaches, the resistance becomes zero. Thus, the surge can be guided to the neutral wire, preventing damage to the 3C product.

The overload protection circuit 24 comprises the fuesless overcurrent switch member 14 with a suitable load according to the number of the three-slot sockets. The switch member 14 can be of automatically or manually resettable type and protect the whole extension cord from overload.

When the plug 16 of the extension cord in accordance with the present invention is coupled with a two-slot socket of an alternating-current power supply, electromagnetic radiation extends to the extension cord. Use of the cable 15 covered with a metal wire-weaved net 10 shields from the electromagnetic waves.

As apparent from the foregoing, the neutral wire of a two-slot socket of an alternating-current power supply is electrically connected by the detecting circuit 21 to a third, grounding slot for a 3C product and thus effectively grounded. An electromagnetic-shielding effect for the 3C product is provided and electromagnetic radiation is eliminated. Further, the arrangement is incorporated into the extension cord to enhance safety and convenience when using the 3C product.

The resettable positive temperature coefficient electric fuse 221 in the grounding circuit 22 avoids electricity leakage and electric shock resulting from misconnection to the hot wire of a two-slot socket. Further, replacement of the electric fuse 221 is not required. The surge protection circuit 23 and the overload protection circuit 24 further enhance the safety when using the extension cord. Further, the neutral wire/hot wire detecting circuit 21 is incorporated into the extension cord in accordance with the present invention, allowing easy, correct grounding while eliminating electromagnetic radiation. Further, use of the metal wire-weaved cable 15 covered with a metal wire-weaved net 10 shields from the electromagnetic waves.

Although a specific embodiment has been illustrated and described, numerous modifications and variations are still possible without departing from the essence of the invention. The scope of the invention is limited by the accompanying claims.

What is claimed is:

1. An extension cord with an electromagnetic radiation-shielding function, comprising:
a body for connecting a two-slot socket to a three-slot socket;
a detecting circuit for detecting a hot wire and a neutral wire of the two-slot socket, the detecting circuit being electrically connected to the body; and
a grounding circuit electrically connected to the body and mounted between the neutral wire of the two-slot socket and a grounding slot of the three-slot socket.

2. The extension cord with an electromagnetic radiation-shielding function as claimed in claim 1 further comprising a cable covered with a metal wire-weaved net for electrical connection with the two-slot socket.

3. The extension cord with an electromagnetic radiation-shielding function as claimed in claim 1 wherein the detecting circuit comprises a slide switch and an indicator, the slide switch comprising a metal housing, the indicator being electrically connected in series to a resistor.

4. The extension cord with an electromagnetic radiation-shielding function as claimed in claim 1 wherein the grounding circuit comprises a resettable positive temperature coefficient electric fuse or a meltable fuse.
